(19) United States
(12) Patent Application Publication
(10) Pub. No.: US 2014/0282373 A1
(43) Pub. Date: Sep. 18, 2014

(54) AUTOMATED BUSINESS RULE HARVESTING WITH ABSTRACT SYNTAX TREE TRANSFORMATION

(71) Applicant: TRINITY MILLENNIUM GROUP, INC., San Antonio, TX (US)

(72) Inventor: David Garza, San Antonio, TX (US)

(73) Assignee: Trinity Millennium Group, Inc., San Antonio, TX (US)

(21) Appl. No.: 13/844,468

(22) Filed: Mar. 15, 2013

(51) Int. Cl. G06F 9/44

(52) U.S. Cl. CPC G06F 8/36
USPC 717/106

(57) ABSTRACT

Business rules may be harvested from software using automated processes and used in developing new computer software. Automated harvesting may speed up development, reduce cost, and decrease human error during software development. Harvesting the business rules from computer software may also allow business analysts to verify and update business rules. The business rules may be harvested by parsing existing source code into abstract syntax trees (ASTs). The source ASTs may then be transformed into target ASTs corresponding to a programming language different from the existing source code. Those target ASTs may then be recomposed into output source code of the different programming language.

### TECHNICAL FIELD

This disclosure is related generally to the field of computer software, more particularly to a system and method for harvesting rules from computer software.

### BACKGROUND

As computer technology evolved over the last few decades, businesses acquired computer hardware and software to enhance productivity and streamline business operations. The software, or the hardware executing the software, may later become antiquated. Antiquated hardware and software may be difficult to service and update. Embedded in hardware and software owned by a business are instructions that describe how the business operates at a high level. These instructions, although developed by programmers and hardware developers, are dictated by business rules specified by business analysts.

A business rule provided to different hardware and software developers may result in distinctly different customized hardware and software. Moreover, business rules and other computer hardware and software may be added or updated by different developers. As a result, identification of business rules within the hardware and software may be a difficult task. Thus, it is sometimes desirable to extract the business rules from the hardware and software and translate the rules back to human-readable terms. For example, when existing computer hardware at a business is being replaced with new computer hardware, the new computer hardware may require computer software written in a different language. In one particular situation, a mainframe computer executing COBOL computer software may be replaced by a Linux-based server. For the Linux-based server, a COBOL compiler may not be available. Thus, the computer software should be reprogrammed in C, or another supported language.

Conventionally, a programmer would review the existing source code and write new software. However, in this process no business analyst is involved to verify or modify operation of the software. Further, it is difficult to involve the business analyst because the analyst usually has no experience with programming languages.

### SUMMARY

A system and method for automating business rule harvesting may decrease costs associated with developing new computer hardware and software. For example, abstract syntax trees for a first programming language may be generated from existing source code and transformed, through the use of grammars and symbol dictionaries, to abstract syntax trees for a second programming language. From the abstract syntax trees, business rules may be extracted. Documents generated with these extracted business rules may be reviewed and modified by a business analyst. The transformed abstract syntax trees, modified by the business analyst, may then be recomposed into new source code in the second programming language.

According to one embodiment, a method includes parsing source code of an existing computer program. The method also includes generating a source abstract syntax tree from the parsed source code. The method further includes transforming the source abstract syntax tree to a target abstract syntax tree. The method also includes generating output source code from the target abstract syntax tree.

According to another embodiment, a computer program product includes a non-transitory computer readable medium having code to parse source code of an existing computer program. The medium also includes code to generate a source abstract syntax tree from the parsed source code. The medium further includes code to transform the source abstract syntax tree to a target abstract syntax tree. The medium also includes code to generate output source code from the target abstract syntax tree.

According to a further embodiment, an apparatus includes a memory and a processor coupled to the memory. The processor is configured to parse source code of an existing computer program. The processor is also configured to generate a source abstract syntax tree from the parsed source code. The processor is further configured to transform the source abstract syntax tree to a target abstract syntax tree. The processor is also configured to generate output source code from the target abstract syntax tree.

The foregoing has outlined rather broadly the features and technical advantages of the present disclosure in order that the detailed description of the disclosure that follows may be better understood. Additional features and advantages of the disclosure will be described hereinafter that form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features that are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the disclosed system and methods, reference is now made to the following descriptions taken in conjunction with the accompanying drawings.

FIG. 1 is a flow chart illustrating a process for developing new computer software from existing computer software according to one embodiment of the disclosure.

FIG. 2 is a screen shot illustrating an abstract syntax tree viewer according to one embodiment of the disclosure.

FIG. 3 is a block diagram illustrating a source code transforming system according to one embodiment of the disclosure.

FIG. 4 is a block diagram illustrating a source code transforming system for generating JAVA source code according to one embodiment of the disclosure.

FIG. 5 is a flow chart illustrating a method for business rule harvesting according to one embodiment of the disclosure.

FIG. 6 is a diagram illustrating an abstract source tree according to one embodiment of the disclosure.

FIG. 7 is a table illustrating a report of extracted business rules according to one embodiment of the disclosure.

FIG. 8 is a flow chart illustrating a method for extracting, transforming, and migrating business rules according to one embodiment of the disclosure.

FIG. 9 is a table illustrating a capture document according to one embodiment of the disclosure.

FIG. 10 illustrates a computer system for transforming source code according to one embodiment of the disclosure.

### DETAILED DESCRIPTION

Business rules may be harvested from software using automated processes. Automated harvesting may speed up development, reduce cost, and decrease human error during software development. Harvesting the business rules from computer software may also allow business analysts to verify and update business rules. By incorporating business analysts in the software development, any discrepancies that may have occurred as a result of the translation of business rules to software may be identified and resolved by a business analyst that clearly understands the functionality of the business rule.

FIG. 1 is a flow chart illustrating a process for developing new computer software from existing computer software according to one embodiment of the disclosure. A method 100 begins at block 102 with characterizing the existing computer software. Block 102 may include high-level analysis of the existing computer software. For example, a baseline report may include the number of files, lines, and bytes of source code. The characterization may also include an analysis of the composition and size of the application, listing a number of files and lines in each programming language. The characterization may further include analyzing the complexity of different files in the source code relative to each other based on the Halstead complexity measurement, the Cyclomatic complexity measurement, and/or the depth complexity measurement.

At block 104, the method 100 mines the knowledge contained within the existing computer software. For example, a detailed analysis of the existing computer software may be performed at block 104. The detailed analysis may include creating a repository of application metadata. The detailed analysis may also include generating a data dictionary, comparing files, comparing blocks, generating flowcharts, generating create, read, update, and delete (CRUD) tables, and/or extracting business rules.

During the characterization and knowledge steps at blocks 102 and 104, abstract syntax trees may be generated describing the source code contained in the existing computer software. An example of an abstract syntax tree is shown in FIG. 2. FIG. 2 is a screen shot illustrating an abstract syntax tree viewer according to one embodiment of the disclosure. An abstract syntax tree 202 may correspond to source code 204. The abstract syntax tree 202 may include a hierarchical organization of nodes corresponding to symbols in the source code 204. In one example, a line of source code 204 recites “SET HEADER 6 ‘NAME’ AT 15.” The corresponding abstract syntax tree 202 may include a node for “SetHeaderOrTrailerStatement” with subnodes corresponding to “Set—‘SET’,” “IntegerNumber—‘6’,” “At—‘AT’,” and “IntegerNumber—‘15.’”

At block 106 of FIG. 1, the existing computer software is transformed into new computer software. The new computer software may be built from the developed high-level characterization at block 102 and the knowledge mined during detailed analysis at block 104. At block 108, the new computer software may be maintained and/or enhanced as the business rules are changed or the underlying computer hardware changes. Additional details regarding the process for developing new computer software may be found in U.S. patent application Ser. No. 11/231,004, which is hereby incorporated by reference in its entirety.

FIG. 3 is a block diagram illustrating a source code transforming system according to one embodiment of the disclosure. Source code 302 of a business software system may include business rules and technical rules. The source code 302 may represent the business rules through the use of variables and the relationship between variables. For example, a statement in the source code 302 adding a value denoted by ‘shipping_cost’ to a value denoted by ‘item_cost’ may represent a business rule for calculating a total cost. The source code 302 may include more than one version of a computer software product. The source code 302 may include static code or dynamic code. Static code may be code defined before runtime of the program specified by the source code 302. Dynamic code may be code that may include new code added at runtime.

Grammars 304 may include rules for a program in a given programming language. This uniquely developed type of grammar may include special features, such as indicating that a given program element is to appear in a specific column. An example of a grammar for the COBOL programming language is provided in Table 1.

TABLE 1
A sample grammar for the COBOL programming language.

(Programs): Program&...;
Program: [ProcessLine...] [SetLine...] [lines...] [BOLRemark]
[lineComment]...

[IdentificationDivision] &
[EnvironmentDivision] &
DataDivision &
[ProcedureDivision]
[Program&...] &
[EndProgram&...];

CopyBook: [(garbageLinesBeforeCopyBook)...]

(DataProc !(Sentence) [AberrantLinkageSection]
| ProcCopyBook
| RecordEntryBlock !(Sentence)
| ForProcedureDiv
| ConfigSection
| [BOLRemark] [WhiteSpace] (SelectParagraph |
FileOptionList‘.’ &

[RecordEntryBlock] | SpecialNameList@SpecialNameList2));

A parser 306 may receive the source code 302 and the grammars 304 as inputs. The parser 306 then parses the source code 302 according to the structure provided in the grammars 304. During parsing, the parser 306 may identify items in the source code 302, such as variables, brackets, and/or assignment operators. When variables are encountered, the variables may be identified as business variables or technical variables. Business variables may include, for example, costs and quantities. Technical variables may include, for example, index variables and counter variables in repeat loops and/or end of file (EOF) variables. The parser 306 may also verify that the source code 302 is correctly formatted according to the definition of the particular programming language in which the software is written.

The parser 306 may create an artifact library 310 and/or create a source abstract syntax tree (AST) 308. An artifact library 310 may be a collection of artifacts generated from analysis tools. The artifact library may include a comma separated value (CSV) file containing symbol definitions and references within legacy source code, database tables containing business rules and create/read/update/delete (CRUD) rules extracted from legacy code, spreadsheet files containing complexity metrics of the legacy source code, and/or graphs describing connections between programs and the flow of control within programs of the legacy source code.

An AST 308 may represent elements found in the source code 302. According to one embodiment, the information provided in a source AST 308 may be hierarchical, as shown in FIG. 2. The source AST 308 may include syntax for copybooks, include statements, data declarations, working storage sections, and routines. The grammars 304 may include grammar for tokenizing and parsing the entirety of the source code 302. Furthermore, the grammars 304 may include grammars for multiple languages. The AST 308 may be mapped to source lines in the source code 302.

A transformer 312 may process the artifact library 310 and the AST 308 to create a target AST 314 and/or a target template 316. The target AST 314 may represent elements found in the source code 302 with the same features as the source AST 308, with the exception that the source AST 308 and the target AST 314 correspond to different programming languages. According to one embodiment, the transformer 312 may also access a library of ASTs from other source code in generating the target AST 314. A target template 316 may be pseudo-code providing instruction to the transformer 312 on how to arrange elements in the AST 314. One example of a target template for a method is provided in Table 2.

TABLE 2
A sample target template for a method.

Method: MethodCore;
(MethodCore): eol\hat{ }’public void’ ParagraphName \hat{ } ’(‘ \hat{ } [Parameters] \hat{ } ‘)’

& %+Margin ‘{‘&
Sentences
%-Margin eol \hat{ } ‘}’ eol eol

| Sentences;
ParagraphName: Identifier;
Parameters: Parameter,...;
Parameter: ParameterType Identifier;
ParameterType: (ClassIdentifier\hat{ }[‘.’\hat{ }ClassIdentifier]...) | %this;

Transformation at the transformer 312 may include restructuring the layout of the AST 308 to fit the capabilities of a target language. For example, some legacy programming languages, such as COBOL, provide a single assignment statement that will populate multiple variables with the same value. When a target language does not support this operation, the portion of the AST 308 for that particular assignment statement may be transformed to expand the single assignment statement to multiple assignment statements compatible with the target language.

According to one embodiment, the transformer 312 may identify patternization practices when transforming the source AST 308 to the target AST 314. The identified patternization practices may identify candidate areas of the source AST 308 that are similar allowing the size of the target AST 314 to be reduced from the size of the source AST 308. For example, through refactoring and re-engineering of procedural repetitions and patterns in legacy source code, the transformer 312 may harvest the patterns to generate objects and/or classes that may replace the patterns within the source AST 308.

Using the target AST 314 and the target template 316, a recomposer 318 may generate output code 320 in a different programming language than the raw source code 302. The output code 320 may perform the same functions, such as business rules, as the raw source code 302, but is coded in a different programming language. The recomposer 318 may generate the output code 320 by reversing the actions performed by the parser 306. As with the parser 306, the recomposer 318 may use the grammars 304 during recomposition.

The system 300 of FIG. 3 may be implemented to transform code from one or more source code programming languages to one or more output code programming languages. For example, the source code 302 may be COBOL and/or FORTRAN, and the output code 320 may be JAVA. One implementation of the system 300 of FIG. 3 for generating JAVA code is shown in FIG. 4. FIG. 4 is a block diagram illustrating a source code transforming system for generating JAVA source code according to one embodiment of the disclosure. A system 400 includes a parser 406 that receives legacy source code 402 and legacy source code grammars 404 and outputs abstract syntax trees 408 corresponding to the legacy source code 402. From the abstract syntax trees 408, an artifact library 410 may be generated. A transformation engine 412 may receive the abstract syntax trees 408 and the artifact library 410 as inputs and generate JAVA-specific syntax trees 414. The JAVA-specific syntax trees 414 contain similar information as the abstract syntax trees 408, but are arranged in nodes corresponding to the structure of the JAVA programming language. A composer 418 reads the JAVA-specific syntax trees 414 and a JAVA grammar database 416 and generates JAVA output code 420.

Business rules may be harvested from the abstract syntax trees generated during the transformation process described above. In harvesting the business rules, additional abstract syntax trees from other source code may be examined. Business rules may be an English-like description of functions performed by the source code, although business rules are not limited to English. By extracting the business rules, a business analyst, as opposed to a programmer, can examine the functionality of the software. That is, the business analyst can understand the function performed by the source code, without reading the source code. The business analyst can verify that the computer software operates according to desired rules. Further, the business analyst can specify changes in the business rules before the code is transformed into an output source code.

FIG. 5 is a flow chart illustrating a method for business rule harvesting according to one embodiment of the disclosure. A method 500 begins at block 502 with parsing, and other analyzing, of the source code of an existing software program. At block 504, abstract syntax trees (ASTs) may be generated, which are a high-level abstraction of the low-level source code. At block 506, symbols may be extracted from the abstract syntax trees and a symbols inventory, containing variables and/or procedures, may be created. At block 508, the terms in the symbols inventory, such as variables and procedures, may be defined and a terms dictionary may be created. The definitions may be generated automatically or manually entered by a developer or business analyst.

At block 510, business rules may be extracted from the abstract syntax trees (AST) along with their associated definitions from the terms dictionary. According to one embodiment, the terms dictionary may be continually updated with terms from source code. As additional source code is analyzed, higher number of terms may be automatically identified by the terms dictionary. Business rules may be identified in the AST by referencing a dictionary of terms within the program and filtering the dictionary of terms to obtain those terms involved in screen, disk, and/or database input/output(I/O). The filtered list of dictionary terms are business variables. Blocks of control-flow in legacy source code may be examined to determine if an operation involves a business variable and a mathematical statement, including an assignment statement. Operations may span one or several lines of code. The operations involving business variables may be considered as business rule candidates. The business rule candidates may optionally be verified by a user as business rules.

FIG. 6 is a diagram showing an abstract syntax tree containing a business rule. At block 510 of FIG. 5, an AST 600 of FIG. 6 may be converted in to the business rule shown in Table 3.

TABLE 3
A sample business rule extracted from an AST.

| | |
|---|---|
| IF WABC.DGNCO EQ 020; | /* ABC is in units |

| | |
|---|---|
| MOVE 063 TO ABC64.DGNCO; | /* move company |

| | |
|---|---|
| ELSE; | /* ...@004 |

MOVE ABC.DGNCO TO ABC64.DGNCO; /* move company

| | |
|---|---|
| END; | /* @004 |

At block 512, the business rules may be documented. According to one embodiment, the documentation of business rules may also include analysis for validation, modifications, and/or review. For example, a business analyst may analyze the business rule documentation created at block 512 to verify that all the business rules extracted are correct. Upon completion of the analysis of the business rules documentation, at block 514, the business rules may be organized into an inventory of business rules. This business rule inventory may assist a business analyst in reviewing the business rules. Thus, the business analyst does not need to view source code, but may still participate in the development of new computer software.

The business rule inventory may be reported in a table. FIG. 7 is a table illustrating a report of extracted business rules according to one embodiment of the disclosure. A table 700 may include rows corresponding to individual business rules and columns corresponding to information for each business rule. A column 702 may include an arbitrary identification number, a column 704 may include a use case number, a column 706 may include a use case name, a column 708 may include a workflow step, a column 710 may include a rule description, a column 712 may include a program identifier, a column 714 may include a paragraph name, a column 716 may include a line number in the program, and a column 718 may include the translated English-like business rule. On example of a business rule in column 718 is “IF MAXIMUM ALLOWED DEBT AMOUNT IS NOT A VALIDLY FORMATTED DOLLAR AMOUNT, THEN MOVE ‘INVALID MAXIMUM ALLOWED DEBT AMOUNT’ TO ERROR MESSAGE.”

FIG. 8 is a flow chart illustrating a method for extracting, transforming, and migrating business rules according to one embodiment of the disclosure. For example, business rules may be captured from an existing information technology (IT). The rules may then be used to enhance migration to new IT systems with minimal loss of business processes. The method 800 may begin at block 802 with executing computer software from the existing IT system and monitoring the execution. Business rules may be extracted by monitoring how the software responds to different inputs during execution of the code. Further, the software source code may be verified as operational. The software source code executed at block 802 to operate the IT system may be the source code 302 of FIG. 3.

At block 804, language constructs of the software source code may be analyzed to extract business rules from the software source code part of the IT system operated at block 802. The software may be analyzed at block 804 by the parser 306 of FIG. 3.

At block 806, English-like capture documents may be generated based, in part, on the business rules extracted at block 804. The capture documents may include business rule documents and/or use case documents. A business rule document may provide documentation for all business rules identified in the source code or link the business rules to the business units to which the business rules apply. The English-like descriptions of variables and source code may be generated automatically from information sources such as previously-translated variables names. For example, the variable ‘idx’ may be known from other software to be an ‘index’ value. In another example, the variable ‘mktval’ may be known from other software to be a ‘market value.’ According to one embodiment, a glossary, which may be industry specific, is used to aid in the translation of variables.

The capture documents may be coordinated with a business alignment document, which identifies business requirements, business functions that support those requirements, and business activities that perform the work for those functions. A map may be created linking business requirements, functions, and activities and the applications that implement the activities along with the application entry point. One example of a capture document is shown in FIG. 9. A capture document 900 may include a list of physical business activities linked to entry points in an information system. For example, a business activity may include a business requirement 902, which includes business functions 904A and 904B that support the business requirement 902, and a business activity 906 that supports the business functions 904A and 904B.

At block 808, concepts may be re-formed from the business rules. Re-forming concepts may include recognizing key concepts, translating the key concepts to simple terms, and/or realigning the key concepts. After re-forming concepts at block 808, the concepts may be analyzed, reviewed, validated, modified, and/or aligned at block 810. For example, a business analyst may verify the business rules are correct and/or augment the business rules with updated rules.

At block 812, a new IT system may be built from the re-formed concepts of block 810. The building process may include refactoring key concepts and code to a modern maintainable state. The building step may be performed by the transformer 312 of FIG. 3. At block 814, the new IT system may be executed and verified as operating the correct business rules. Software executing on the new IT system may be compiled from the output code 320 of FIG. 3. According to another embodiment, documentation may be produced that compares the generated one or more business rules with pre-established business rules provided by business analysts.

The business harvesting rule described above allows an information system manager or a business manager to reverse engineer a company's business rules from the information system. Code for managing a company's information often evolve over time and are poorly documented. As the business develops, an understanding of the everyday functions of the company may be lost as more features are added to the information system. Business rule harvesting of source code as described above allows these lost rules to be recaptured by an information system manager or a business manager. The business rules may then be coded in a modern computer language for a modern computer architecture. The transformation of legacy source code into modern source code allows information system managers or business managers to upgrade legacy information systems without concern that business rules, not documented elsewhere, will be lost.

FIG. 10 illustrates a computer system 1000 for transforming source code according to one embodiment of the disclosure. A central processing unit (“CPU”) 1002 is coupled to a system bus 1004. The CPU 1002 may be a general purpose CPU or microprocessor, graphics processing unit (“GPU”), and/or microcontroller. The present embodiments are not restricted by the architecture of the CPU 1002 so long as the CPU 1002, whether directly or indirectly, supports the modules and operations as described herein. The CPU 1002 may execute various logical instructions according to the present embodiments.

The computer system 1000 also may include random access memory (RAM) 1008, which may be synchronous RAM (SRAM), dynamic RAM (DRAM), and/or synchronous dynamic RAM (SDRAM), or the like. The computer system 1000 may use RAM 1008 to store the various data structures used by a software application. The computer system 1000 may also include read only memory (ROM) 1006, which may be PROM, EPROM, EEPROM, optical storage, or the like. The ROM 1006 may store configuration information for booting the computer system 1000. The RAM 1008 and the ROM 1006 may store user and system data, such as source code and representation of business rules.

The computer system 1000 may also include an input/output (I/O) adapter 1010, a communications adapter 1014, a user interface adapter 1016, and a display adapter 1022. The I/O adapter 1010 and/or the user interface adapter 1016 may, in certain embodiments, enable a user to interact with the computer system 1000.

The I/O adapter 1010 may couple one or more storage devices 1012, such as one or more of a hard drive, a solid state storage device, a flash drive, a compact disc (CD) drive, a floppy disk drive, or a secure digital card, to the computer system 1000. According to one embodiment, the data storage 1012 may be a separate server coupled to the computer system 1000 through a network connection to the I/O adapter 1010. The communications adapter 1014 may be adapted to couple the computer system 1000 to a network, which may be one or more of a LAN, WAN, and/or the Internet. For example, source code may be stored on a data storage device located on the network separate from a computer system processing the source code with a parser. The user interface adapter 1016 couples user input devices, such as a keyboard 1020, a pointing device 1018, and/or a touch screen (not shown) to the computer system 1000. The display adapter 1022 may be driven by the CPU 1002 to control the display on the display device 824.

The applications of the present disclosure are not limited to the architecture of computer system 1000. Rather the computer system 1000 is provided as an example of one type of computing device that may be adapted to perform the functions of a computer system for transforming source code. For example, any suitable processor-based device may be use including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may use any number of suitable structures capable of executing logical operations according to the described embodiments.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the present processes, disclosure, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
parsing source code of an existing computer program;
generating a source abstract syntax tree from the parsed source code, the source abstract syntax tree including syntax for include statements, data declarations, and routines;
transforming the source abstract syntax tree to a target abstract syntax tree; and
generating output source code from the target abstract syntax tree.

2. The method of claim 1, further comprising extracting symbols from the source abstract syntax tree.

3. The method of claim 2, in which the step of extracting symbols comprises extracting variable names.

4. The method of claim 3, in which the step of extracting variable names comprises categorizing variable names as business variables and technical variables.

5. The method of claim 2, further comprising defining the symbols based, in part, on a symbol dictionary.

6. The method of claim 5, in which the step of transforming the source abstract syntax tree comprises extracting business rules from the source abstract syntax tree.

7. The method of claim 6, in which the step of extracting business rules from the source abstract syntax tree comprises extracting business rules from the source abstract syntax tree and generic abstract syntax trees.

8. A computer program product, comprising:
a non-transitory computer readable medium comprising:
code to parse source code of an existing computer program;
code to generate a source abstract syntax tree from the parsed source code, the source abstract syntax tree including syntax for include statements, data declarations, and routines;
code to transform the source abstract syntax tree to a target abstract syntax tree; and
code to generate output source code from the target abstract syntax tree.

9. The computer program product of claim 8, in which the medium further comprises code to extract symbols from the source abstract syntax tree.

10. The computer program product of claim 9, in which the medium further comprises code to extract variable names and code to categorize variable names as business variables and technical variables.

11. The computer program product of claim 10, in which the medium further comprises code to define the symbols based, in part, on a symbol dictionary.

12. The computer program product of claim 8, in which the medium further comprises code to extract business rules from the source abstract syntax tree.

13. The computer program product of claim 12, in which the medium further comprises code to extract business rules from the source abstract syntax tree and generic abstract syntax trees.

14. An apparatus, comprising:
a memory; and
a processor coupled to the memory, in which the processor is configured:
to parse source code of an existing computer program;
to generate a source abstract syntax tree from the parsed source code, the source abstract syntax tree including syntax for include statements, data declarations, and routines;
to transform the source abstract syntax tree to a target abstract syntax tree; and
to generate output source code from the target abstract syntax tree.

15. The apparatus of claim 14, in which the processor is further configured to extract symbols from the source abstract syntax tree.

16. The apparatus of claim 15, in which the processor is further configured to extract variable names and to categorize variable names as business variables and technical variables.

17. The apparatus of claim 16, in which the processor is further configured to define the symbols based, in part, on a symbol dictionary.

18. The apparatus of claim 14, in which the processor is further configured to extract business rules from the source abstract syntax tree.

19. The apparatus of claim 18, in which the processor is further configured to extract business rules from the source abstract syntax tree and generic abstract syntax trees.
